(19) United States
(12) Patent Application Publication
(10) Pub. No.: US 2017/0264937 A1
(43) Pub. Date: Sep. 14, 2017

(54) METHOD AND APPARATUS FOR GENERATING ENVIRONMENT SETTING INFORMATION OF DISPLAY DEVICE

(71) Applicant: Samsung Electronics Co., Ltd., Suwon-si (KR)

(72) Inventors: Seong-wook JEONG, Seoul (KR); Kyung-jin KIM, Seoul (KR); Min-hyung KIM, Seoul (KR); Ga-min PARK, Seoul (KR); Hyo-seung PARK, Seoul (KR); So-yon YOU, Seoul (KR); Kwan-min LEE, Seoul (KR); Sang-joon LEE, Dangjin-si (KR); Jun-woo LEE, Seoul (KR); Kyung-hwa JUNG, Anyang-si (KR)

(73) Assignee: Samsung Electronics Co., Ltd., Suwon-si (KR)

(21) Appl. No.: 15/454,594

(22) Filed: Mar. 9, 2017

(30) Foreign Application Priority Data
Mar. 11, 2016 (KR) 10-2016-0029670

(51) Int. Cl. H04N 21/41; H04L 12/28; H04N 21/436; H04N 21/422

(52) U.S. Cl. CPC H04N 21/4131; H04N 21/42202; H04L 12/2827; H04N 21/43615; H04L 2012/2849

(57) ABSTRACT

A display device includes a display, and a processor configured to receive environment setting information that is used to view content currently being displayed on the display, acquire metadata associated with the content displayed on the display, and generate a user's viewing environment by mapping the metadata to the environment setting information.

### CROSS-REFERENCE TO RELATED APPLICATIONS

This application claims the priority benefit of Korean Patent Application No. 10-2016-0029670, filed on Mar. 11, 2016, in the Korean Intellectual Property Office, the disclosure of which is incorporated herein in its entirety by reference.

### BACKGROUND

1. Field

The disclosure relates to methods of setting a viewing environment for a display device.

2. Description of the Related Art

Due to advances in smart television (TV) technology and technology related to various external devices that can connect to a TV, the types of content that may be displayed on a display device have become significantly diverse. Thus, it is necessary to respectively set viewing environments suitable for various kinds of content.

Furthermore, advancements in Internet of Things (IoT) technology have improved technology for controlling various external devices together with a display device.

### SUMMARY

Provided are methods and apparatuses for generating environment setting information regarding a display device.

Additional aspects and/or advantages will be set forth in part in the description which follows and, in part, will be apparent from the description, or may be learned by practice of the disclosed embodiments.

According to an aspect of an embodiment, a display device includes: a display, and a processor configured to receive environment setting information that is used to view content currently being displayed on the display, acquire metadata associated with the content displayed on the display, and generate a user's viewing environment by mapping the metadata to the environment setting information.

The processor is further configured to set the display device based on the generated user's viewing environment when at least one other piece of content corresponding to the metadata is displayed on the display.

The processor is further configured to generate, in response to a user input signal for selecting a specific item arranged in a user interface, the user's viewing environment by mapping the metadata to the environment setting information.

The display device may further include a communication unit configured to receive the content from an external device, and the metadata may include information about the external device.

The display device is further configured to set the display device itself, based on the generated user's viewing environment when the external device is connected to the display device.

The environment setting information may be obtained by the user editing preset environment setting information.

The processor is further configured to set a name of the user's viewing environment based on the metadata.

The processor is further configured to acquire the set name of the user's viewing environment and update the name based on a viewing pattern for at least one piece of content to which the user's viewing environment is applied.

The environment setting information may include setting information about at least one external device, and the display device may further include a communication unit configured to transmit, when at least one other piece of content corresponding to the metadata is displayed on the display, a control signal for controlling the at least one external device connected to the display device.

According to an aspect of another embodiment, a method, performed by a display device, of generating a user's viewing environment includes: receiving environment setting information that is used to view content currently being displayed on a display, acquiring metadata associated with the content displayed on the display, and generating a user's viewing environment by mapping the metadata to the environment setting information.

The method may further include setting the display device based on the generated user's viewing environment when at least one other piece of content corresponding to the metadata is displayed on the display.

The generating of the user's viewing environment may include generating, in response to a user input signal for selecting a specific item arranged in a user interface, the user's viewing environment by mapping the metadata to the environment setting information.

The method may further include receiving the content from an external device, and the metadata may include information about the external device.

The method may further include setting the display device based on the generated user's viewing environment when the external device is connected to the display device.

The environment setting information may be obtained by the user editing preset environment setting information.

The generating of the user's viewing environment may include setting a name of the user's viewing environment based on the metadata.

The method may further include: acquiring the set name of the user's viewing environment, and updating the name based on a viewing pattern for at least one piece of content to which the user's viewing environment is applied.

The environment setting information may include setting information about at least one external device, and the method may further include transmitting, when at least one other piece of content corresponding to the metadata is displayed on the display, a control signal for controlling the at least one external device connected to the display device.

According to an aspect of another embodiment, a non-transitory computer-readable recording medium has recorded thereon a program for performing the method of generating a user's viewing environment via the display device.

### BRIEF DESCRIPTION OF THE DRAWINGS

These and/or other aspects will become apparent and more readily appreciated from the following description of the embodiments, taken in conjunction with the accompanying drawings in which:

FIG. 1 is a simplified block diagram of a configuration of a display device for generating a user's viewing environment, according to an embodiment;

FIG. 2 is a detailed block diagram of a configuration of a display device according to an embodiment;

FIG. 3 is a flowchart of a method, performed by a display device, of generating a user's viewing environment, according to an embodiment;

FIG. 4 is a flowchart of a method of setting a display device, according to an embodiment;

FIG. 5 is a flowchart of a method, performed by a display device, of generating a user's viewing environment, according to an embodiment;

FIG. 6 is a flowchart of a method of updating a name of a user's viewing environment, according to an embodiment;

FIG. 7 illustrates a method of selecting a user's viewing environment, according to an embodiment;

FIG. 8 illustrates a method of generating a user's viewing environment, according to an embodiment;

FIG. 9 illustrates a method of arranging the user's viewing environment generated according to the method of FIG. 8;

FIG. 10 illustrates a method whereby a display device receives content from an external device, according to an embodiment;

FIG. 11 illustrates a method whereby a display device controls an external device, according to an embodiment;

FIG. 12 illustrates a method of setting a viewing environment, according to an embodiment; and

FIG. 13 shows a detailed example in which a display device controls the display device itself and the external device by using an extended user's viewing environment, according to an embodiment.

### DETAILED DESCRIPTION

Reference will now be made in detail to embodiments, examples of which are illustrated in the accompanying drawings, wherein like reference numerals refer to like elements throughout. In this regard, the embodiments may have different forms and should not be construed as being limited to the descriptions set forth herein. Accordingly, the embodiments are merely described below, by referring to the figures, to explain aspects thereof. Expressions such as “at least one of,” when preceding a list of elements, modify the entire list of elements and do not modify the individual elements of the list.

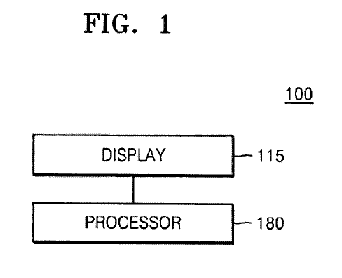

FIG. 1 is a simplified block diagram of a configuration of a display device 100 for generating a user's viewing environment according to an embodiment. Referring to FIG. 1, the display device 100 according to the embodiment includes a processor 180 and a display 115.

According to an embodiment, the display 115 displays content. The content displayed on the display 115 may include at least one of a real-time TV image, a video, a photo, a game, a web page, a document, and an application, but is not limited thereto.

The processor 180 receives environment setting information that is used to view content currently being displayed on the display 115. The environment setting information may include at least one of a resolution, a screen size, a brightness, a contrast, a presence or absence of subtitles, a volume, and sound equalizer settings, but is not limited thereto.

According to an embodiment, the environment setting information may be obtained by the user editing preset environment setting information.

The processor 180 may acquire metadata for content displayed on the display 115. The metadata for the content may include at least one of a type, a genre, a title, and details of the content, but is not limited thereto.

According to an embodiment, the metadata may include information about the time when the content is displayed. Furthermore, the metadata may include information about an external device connected to the display device 100.

The processor 180 may generate the user's viewing environment by mapping the metadata to the environment setting information. According to an embodiment, the processor 180 may set a name of the user's viewing environment based on the metadata and the environment setting information.

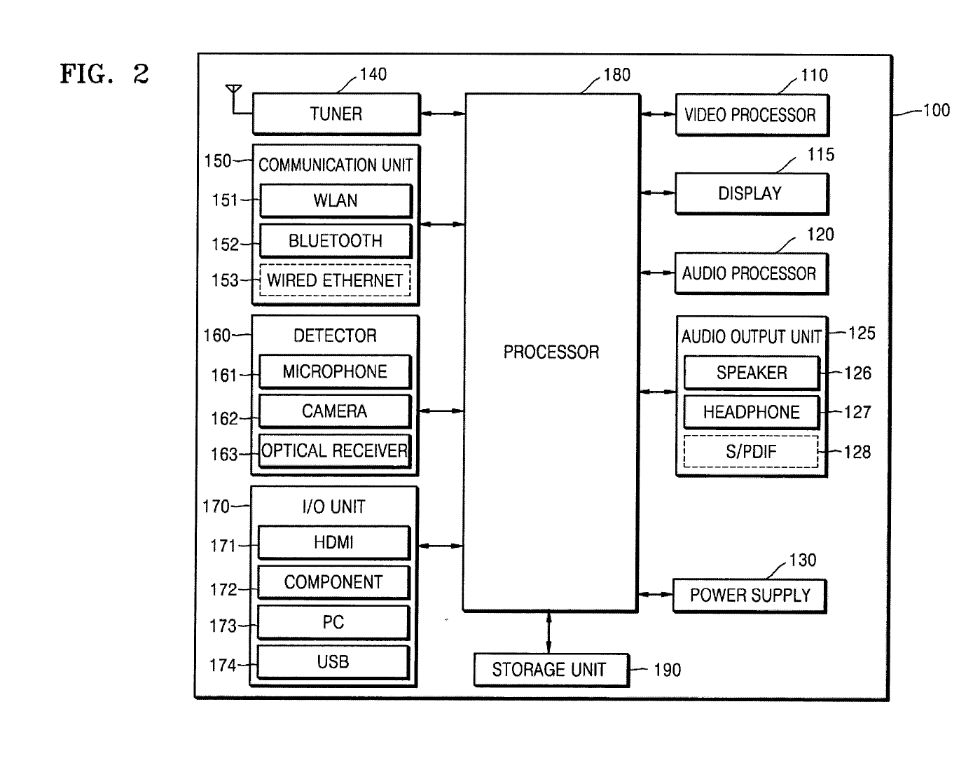

FIG. 2 is a detailed block diagram of a configuration of a display device 100 according to an embodiment.

Referring to FIG. 2, the display device 100 includes a video processor 110, a display 115, an audio processor 120, an audio output unit 125, a power supply 130, a tuner 140, a communication unit 150, a detector 160, an input/output (I/O) unit 170, and a storage unit 190.

The video processor 110 processes video data received by the display device 100. The display 115 is controlled by the processor 180 to display, on a screen, video contained in a broadcasting signal that is received via the tuner 140. Furthermore, the display 115 may display content (e.g., a moving image) being input via the communication unit 150 or the I/O unit 170.

The audio processor 120 may process audio data. The audio output unit 125 is controlled by the processor 180 to output audio contained in a broadcasting signal that is received via the tuner 140. The audio output unit 125 may include a combination of a speaker 126, a headphone output terminal 127, and a Sony/Phillips Digital Interface (S/PDIF) output terminal 128.

The power supply 130 is controlled by the processor 180 to supply power input by an external power source to internal components 110 through 190 of the display device 100.

The tuner 140 may tune and select only a desired channel frequency to be received by the display device 100 from among a number of radio wave components by performing amplification, mixing, and resonance on a broadcasting signal received by wire or wirelessly. The broadcasting signal may include audio, video, and additional information (e.g., electronic program guide (EPG)).

The communication unit 150 may be controlled by the processor 180 to connect the display device 100 with an external device such as an audio device. According to an embodiment, the processor 180 may receive environment setting information including setting information regarding at least one external device. In this case, the communication unit 150 may be controlled by the processor 180 to transmit a control signal for controlling the external device.

According to another embodiment, the communication unit 150 may be controlled by the processor 180 to receive content from an external device. In this case, metadata for the content may include information about the external device.

For example, the processor 180 may connect the display device 100 to an external device such as a smartphone via the communication unit 150. The communication unit 150 may be controlled by the processor 180 to receive from the external device mirroring information including a screen displayed on the external device.

The processor 180 may control the display 115 to display the screen displayed on the external device. In this case, the processor 180 may modify environment setting information including a size and a resolution of the screen.

According to an embodiment, the processor 180 creates a user's viewing environment associated with the external device by mapping the modified environment setting information to the metadata for the content.

According to an embodiment, when an external device connected via the communication unit 150 is a device for which a user's viewing environment has been previously created, the processor 180 may set the display device 100 based on the previously created user's viewing environment.

The detector 160 detects a user's voice, image, or interaction. A microphone 161 receives a user's uttered voice. A camera 162 receives an image (e.g., consecutive frames) corresponding to a user's motion including his or her gesture performed within a range that can be recognized by the camera 162.

An optical receiver 163 receives optical signals (including a control signal), which are received from an external control device, via an optical window (not shown) in a bezel of the display 115.

In an embodiment, the processor 180 may receive environment setting information from the user via the optical receiver 163. Furthermore, the processor 180 may receive a user input signal for selecting a specific item arranged in a user interface via the optical receiver 163.

In response to the received user input signal, the processor 180 may create a user's viewing environment by mapping metadata for content currently being displayed on the display 115 to the received environment setting information.

The I/O unit 170 is controlled by the processor 180 to receive video (e.g., a moving image, etc.), audio (e.g., a voice, music, etc.), additional information (e.g., EPG, etc.), etc., from outside the display device 100. The I/O unit 170 may include one or more of a high-definition multimedia interface (HDMI) port 171, a component jack 172, a PC port 173, and a universal serial bus (USB) port 174. The I/O unit 170 may include a combination of the HDMI port 171, the component jack 172, the PC port 173, and the USB port 174.

According to an embodiment, the I/O unit 170 may be controlled by the processor 180 to receive content from an external device. In this case, metadata for the content may include information about the external device.

For example, the processor 180 may connect the display device 100 to an external device (a DVD player, a game machine, etc.) by using the I/O unit 170.

The processor 180 may control the display 115 to display the received content. In this case, the processor 180 may modify environment setting information including a size and a resolution of a screen.

According to an embodiment, the processor 180 may generate a user's viewing environment associated with the external device by mapping the modified environment setting information to the metadata for the content.

According to an embodiment, when an external device, for which a user's viewing environment has been previously created, is connected via the I/O unit 170, the processor 180 may set the display device 100 based on the previously created user's viewing environment.

The processor 180 controls overall operations of the display device 100 and a flow of signals among the internal components 110 through 190 of the display device 100 and performs a function of processing data. When a user input is performed or stored preset requirements are satisfied, the processor 180 may execute an operating system (OS) and various applications stored in the storage unit 190.

According to an embodiment, the processor 180 may store the created user's viewing environment in the storage unit 190. Furthermore, when at least one other piece of content corresponding to metadata associated with the stored user's viewing environment is displayed on the display 115, the processor 180 may set the display device 100 based on the user's viewing environment.

For example, if a movie is currently being displayed on the display 115, the processor 180 may receive environment setting information used in viewing the movie. The processor 180 may generate a user's viewing environment by mapping metadata indicating that a type of the content currently being displayed is a “movie” to the received environment setting information.

The processor 180 may set a name of a user's viewing environment based on metadata. For example, the processor 180 may set the name of the user's viewing environment to a “movie mode”.

Thereafter, when another piece of content is displayed on the display 115, the processor 180 may check metadata for the other piece of content. If the metadata corresponds to a “movie,” the processor 180 may set the display device 100 based on a “movie mode” that is one of the stored user's viewing environments.

In an embodiment, the processor 180 may acquire a name of a user's viewing environment. The processor 180 may update the name of the user's viewing environment based on a viewing pattern for at least one piece of content to which the user's viewing environment is applied.

For example, the processor 180 may recognize that the name of the user's viewing environment is a “movie mode”. If the “movie mode” is frequently used on weekends, the processor 180 may update the name of the user's viewing environment as being a “weekend movie mode” so that the name of the user's viewing environment may reflect an actual viewing pattern of the user more adaptively.

Those of ordinary skill in the art will readily understand that various changes may be made to a configuration and an operation of the processor 180 according to embodiments.

The storage unit 190 may be controlled by the processor 180 to store various types of data, programs, or applications for driving and controlling the display device 100. In detail, the storage unit 190 may store input/output signals or data corresponding to signals or data for driving the video processor 110, the display 115, the audio processor 120, the audio output unit 125, the power supply 130, the tuner 140, the communication unit 150, the detector 160, and the I/O unit 170. The storage unit 190 may store control programs for controlling the display device 100 and the processor 180, applications initially provided by a manufacturer or downloaded from outside, graphical user interfaces (GUIs) associated with the applications, objects (e.g., images, text, icons, buttons, etc.) for providing the GUIs, user information, documents, databases, or related data.

According to an embodiment, the storage unit 190 may store one or more instructions for receiving environment setting information used in viewing content currently being displayed on the display 115, acquiring metadata for the content, and generating a user's viewing environment by mapping the metadata to the environment setting information.

According to an embodiment, the storage unit 190 may store environment setting information received via the optical receiver 163. The environment setting information may include information for setting a category corresponding to a plurality of item regions.

For example, the environment setting information may include at least one of a resolution, a screen size, a brightness, a contrast, presence or absence of subtitles, a volume, and sound equalizer settings, but is not limited thereto.

Furthermore, the display device 100 including the display 115 may be electrically connected to a separate external device (not shown) such as a set-top box. For example, the display device 100 may be implemented as an analog TV, a digital TV, a three-dimensional (3D) TV, a smart TV, a light-emitting diode (LED) TV, an organic light-emitting diode (OLED) TV, a plasma TV, a monitor, etc., but is not limited thereto as will be readily understood by those of ordinary skill in the art.

The display device 100 may further include a sensor (not shown) for detecting an internal or external state of the display device 100, such as an illumination sensor and a temperature sensor.

At least one of the components (e.g., 110 through 190) of the display device 100 shown in FIG. 2 may be added or removed according to the performance of the display device 100. Furthermore, it will be readily understood by those of ordinary skill in the art that locations of the components (e.g., 110 through 190) may vary depending on the performance or structure of the display device 100.

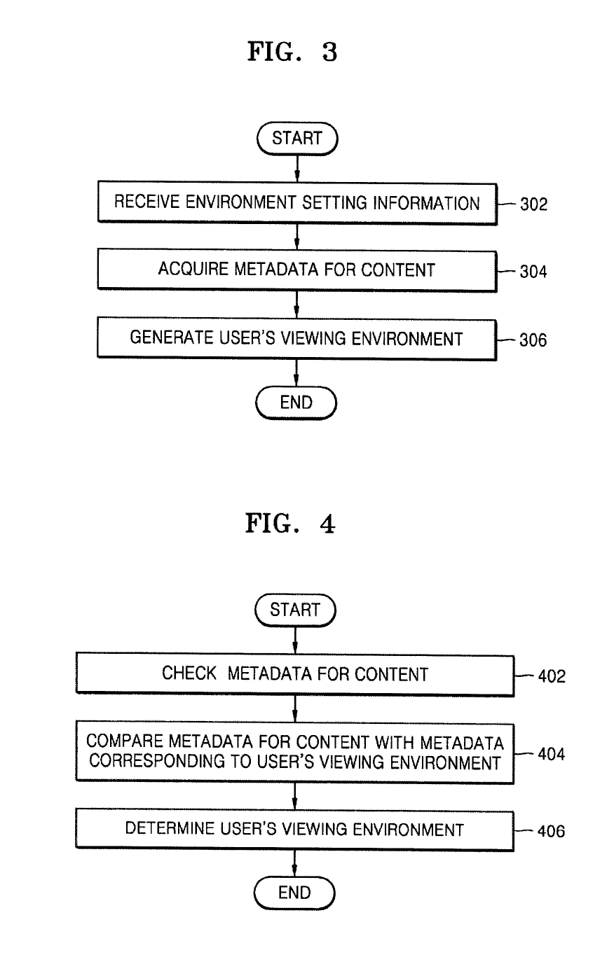

FIG. 3 is a flowchart of a method, performed by the display device (100 of FIG. 2), of generating a user's viewing environment according to an embodiment

The method of generating a user's viewing environment according to the embodiment may be performed by the display device 100 described with reference to FIG. 2 and include the same operations as performed by the display device 100.

The display device 100 receives environment setting information that is used to view content currently being displayed on the display device 100 (operation 302). The content displayed on the display device 100 may include at least one of a real-time TV image, a video, a photo, a game, a web page, a document, and an application, but is not limited thereto.

The environment setting information used to view the content may include at least one of a resolution, a screen size, a brightness, a contrast, presence or absence of subtitles, a volume, and sound equalizer settings, but is not limited thereto.

The display device 100 acquires metadata for the content displayed on the display device 100 (operation 304). The metadata for the content may include at least one of a type, a genre, a title, and details of the content, but is not limited thereto.

According to an embodiment, the metadata for the content may include information about the time when the content is displayed. Furthermore, the metadata for the content may include information about an external device connected to the display device 100.

The display device 100 generates a user's viewing environment by mapping the metadata for the content to the environment setting information (operation 306). In an embodiment, the display device 100 may set a name of the user's viewing environment based on the metadata and the environment setting information.

FIG. 4 is a flowchart of a method of setting the display device 100 according to an embodiment.

The display device 100 may check metadata for content (operation 402). According to an embodiment, the metadata for the content may include at least one piece of information from among information about details of the content, information about the time when the content is displayed, and information about an external device connected to the external device.

The display device 100 may compare the metadata for the content with metadata associated with a user's viewing environment stored in the display device 100 (operation 404). In an embodiment, the content may include a plurality of pieces of metadata.

For example, if the user uses a “DVD player” to watch an “action movie” in “the evening on the weekend,” the content may include a plurality of pieces of metadata.

The display device 100 may determine a user's viewing environment that is used to display the content (operation 406). The display device 100 may be set based on the determined user's viewing environment.

The display device 100 may determine a user's viewing environment corresponding to metadata that is most similar to the metadata for the content displayed on the display device 100. According to an embodiment, if the content includes a plurality of pieces of metadata, the display device 100 may determine a user's viewing environment corresponding to a greatest number of pieces of metadata from among user's viewing environments stored in the display device 100.

In another embodiment, the display device 100 may set priorities among pieces of metadata. For example, if the user uses a “DVD player” to watch an “action movie” in “the evening on the weekend,” the display device 100 may preferentially determine a user's viewing environment set according to the “DVD player”.

If there are a plurality of user's viewing environments corresponding to the “DVD player,” the display device 100 may then determine a user's viewing environment set according to a “movie,” from among the plurality of viewing environments corresponding to the “DVD player”.

If there are a plurality of user's viewing environments corresponding to the “movie,” the display device 100 may then determine a user's viewing environment corresponding to an “action,” from among the plurality of viewing environments corresponding to the “movie”.

Lastly, the display device 100 may determine a user's viewing environment set according to “the evening” or “the evening on the weekend”.

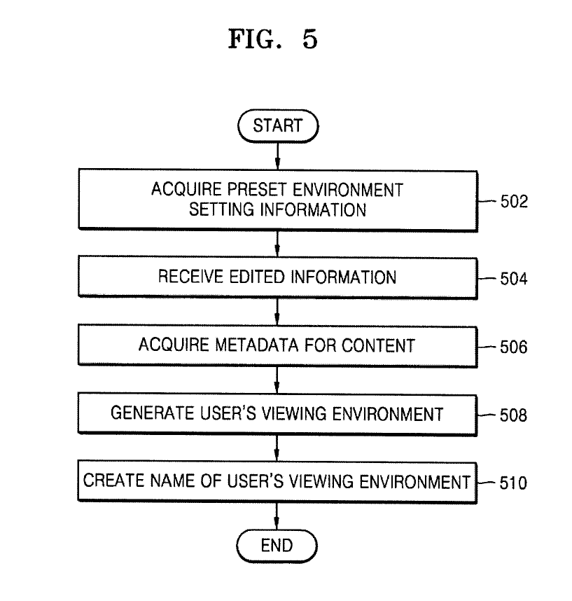

FIG. 5 is a flowchart of a method, performed by the display device 100, of generating a user's viewing environment according to an embodiment.

The display device 100 may acquire preset environment setting information (operation 502). For example, the display device 100 may include environment setting information preset in the display device 100, such as a “sports mode,” a “soccer mode,” a “soccer mode,” and a “concert mode,” in order to provide optimal viewing of content in each category.

The display device 100 may receive, from the user, an input for selecting one piece of information from among the preset environment setting information.

The display device 100 may receive a user input for editing the environment setting information selected in operation 502 (operation 504). For example, the display device 100 may receive information obtained by editing at least one of a resolution, a screen size, a brightness, a contrast, presence or absence of subtitles, a volume, and sound equalizer settings included in the selected environment setting information.

The display device 100 may acquire metadata for content currently being displayed on the display device 100 (operation 506). For example, the display device 100 may acquire at least one of a type, a genre, a title, and details of the content.

The display device 100 may generate a new user's viewing environment by mapping the edited environment setting information to the metadata for the content displayed on the display device 100 (operation 508).

According to an embodiment, in response to a user input signal for selecting a specific item arranged in a user interface, the display device 100 may generate a user's viewing environment by mapping the metadata to the environment setting information.

For example, the display device 100 may generate a user's viewing environment in response to a user input signal indicating selection of an item for storing current environment setting information.

The display device 100 may set a name of the generated user's viewing environment (operation 510). The name of the generated user's viewing environment may be set by specifying a name of the preset environment setting information, or be newly set.

For example, if a new user's viewing environment is generated by editing a “sports mode,” the display device 100 may set a name of the new user's viewing environment based on metadata for the content currently being displayed on the display device 100. If the metadata for the content corresponds to “baseball,” the display device 100 may set the name of the user's viewing environment to a “baseball mode” or “sports-baseball mode”.

If the metadata for the content is irrelevant to sports, the display device 100 may set a new name for the user's viewing environment. For example, if the metadata for the content corresponds to “news,” the display device 100 may set the name of the user's viewing environment to a “news mode”.

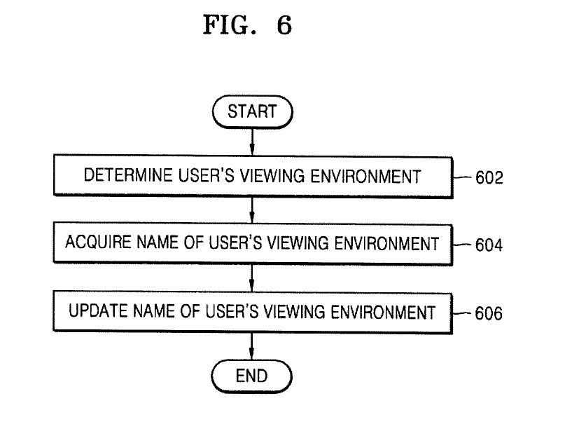

FIG. 6 is a flowchart of a method of updating a name of a user's viewing environment according to an embodiment.

The display device 100 may determine a user's viewing environment that is used to view content currently being displayed on the display device 100 (operation 602).

According to an embodiment, the display device 100 may determine a user's viewing environment including metadata that is most similar to metadata for the currently displayed content.

The display device 100 may acquire a name of the determined user's viewing environment (S604). For example, the name of the determined user's viewing environment may be a “movie mode”.

The display device 100 may update the name of the user's viewing environment (operation 606). The display device 100 may update the name of the user's viewing environment based on a viewing pattern for at least one piece of content to which the user's viewing environment is applied.

For example, the display device 100 may check that the name of the user's viewing environment is a “movie mode”. If the “movie mode” is frequently used on weekends, the display device 100 may update the name of the user's viewing environment as being a “weekend movie mode”.

Furthermore, if the “movie mode” is frequently used to view an “action movie,” the display device 100 may update the name of the user's viewing environment as being an “action movie mode”.

In another embodiment, the display device 100 may receive a user input for editing environment setting information included in the “movie mode”. For example, the display device 100 may receive information obtained by editing at least one of a resolution, a screen size, a brightness, a contrast, presence or absence of subtitles, a volume, and sound equalizer settings included in the movie mode.

The display device 100 may acquire metadata for the content currently being displayed on the display device 100. For example, the display device 100 may acquire at least one of a type, a genre, a title, and details of the content.

The display device 100 may generate a new user's viewing environment by mapping the edited environment setting information to the metadata for the content. In this case, the display device 100 may update the previous name of the user's viewing environment and store a new name thereof.

For example, the metadata for the content currently being displayed on the display device 100 may correspond to an “action movie”. The display device 100 may set the display device 100 by selecting a “movie mode” including a “movie” corresponding to metadata that is most similar to the “action movie”.

The display device 100 may receive information obtained by editing at least one of a resolution, a screen size, a brightness, a contrast, presence or absence of subtitles, a volume, and sound equalizer settings.

In response to a user input signal for selecting a specific item arranged in a user interface, the display device 100 may generate a user's viewing environment by mapping the metadata for the content to the edited environment setting information.

For example, the display device 100 may generate a user's viewing environment based on a user input intended to select an item for storing current environment setting information. Furthermore, the display device may update the name of the user's viewing environment as being an “action movie mode” and store the same.

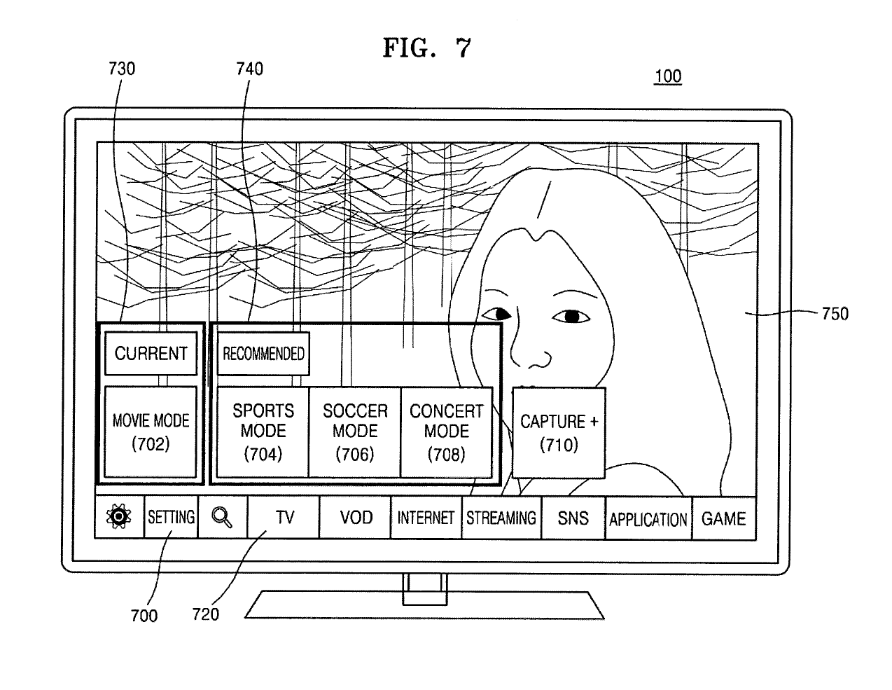

FIG. 7 illustrates a method of selecting a user's viewing environment according to an embodiment.

Referring to FIG. 7, a plurality of items may be arranged in a user interface of the display device 100. For example, the user interface of the display device 100 may include a setting item 700 and a plurality of items 720 for selecting content.

According to an embodiment, the display device 100 may receive environment setting information from the user via the optical receiver 163 described with reference to FIG. 2. Furthermore, the display device 100 may receive, via the optical receiver 163, a user input signal for selecting a specific item from among the setting item 700 and the plurality of items 720 arranged in the user interface.

For example, the display device 100 may display content based on a user input for selecting one of the plurality of items 720. Furthermore, the display device 100 may start a setting mode based on a user input for selecting the setting item 700

When in the setting mode, the display device 100 may display one or more preset user's viewing environments such as a movie mode 702, a sports mode 704, a soccer mode 706, and a concert mode 708. Referring to FIG. 7, the display device 100 may display a current mode 730 representing a current user's viewing environment. Referring to FIG. 7, the display device 100 may be set based on the movie mode 702.

The display device 100 may display a recommended mode arrangement 740. The display device 100 may also receive a user input signal for selecting one mode from among the sports mode 704, the soccer mode 706, and the concert mode 708 included in the recommended mode arrangement 740. The display device 100 may set itself based on the selected user's viewing environment.

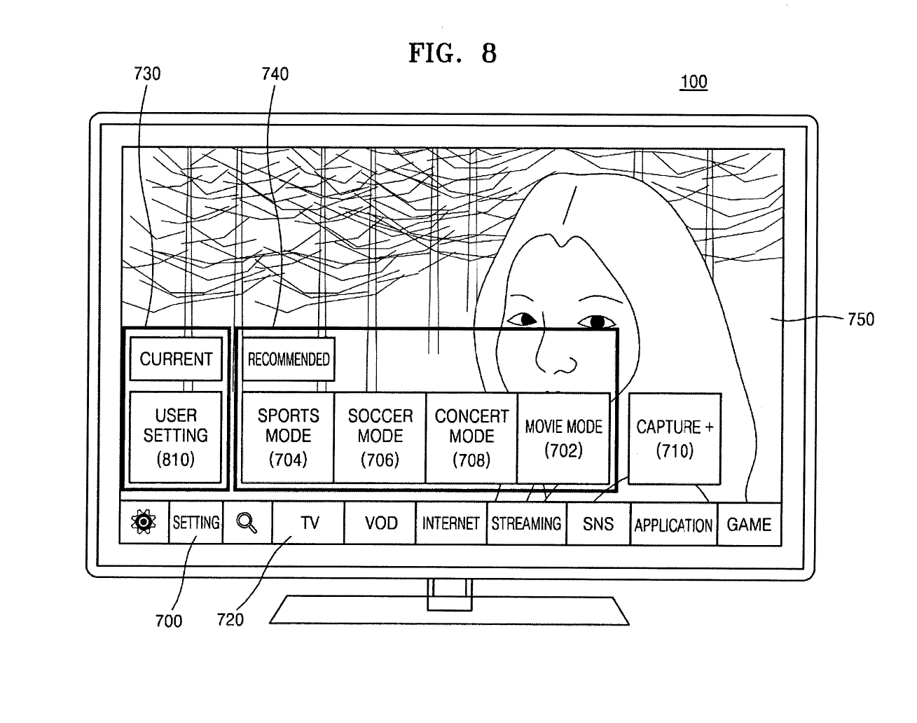

FIG. 8 illustrates a method of generating a user's viewing environment according to an embodiment.

According to an embodiment, the user may directly edit each piece of environment setting information stored in the display device 100. In this case, a current mode 730 may be displayed as being a “user setting” 810.

According to an embodiment, the display device 100 may receive a user input signal for selecting an item “capture” 710. In this case, the display device 100 may generate a user's viewing environment in response to the user input signal for selecting the item “capture” 710.

The display device 100 may generate a new user's viewing environment by mapping metadata for content currently being displayed on the display device 100 to edited environment setting information.

The display device 100 may set a name of the generated user's viewing environment. For example, if the metadata for the content currently being displayed on the display device 100 corresponds to a “drama,” the display device 100 may set the name of the generated user's viewing environment to a “drama mode”.

In an embodiment, the user may edit each piece of environment setting information stored in the display device 100 based on a preset user's viewing environment. For example, if the user selects a movie mode 702 stored in the display device 100, the display device 100 may set itself based on the movie mode 702.

In this case, items associated with the movie mode 702 may be displayed in the current mode 730 on the display device 100. The display device 100 may receive a user input for editing at least one piece of information from among pieces of environment setting information included in the movie mode 702.

If a user input signal for selecting the item “capture” 710 is received, the display device 100 may generate a user's viewing environment in response to the user input signal.

The display device 100 may generate a new user's viewing environment by mapping metadata for content currently being displayed on the display device 100 to edited environment setting information. In this case, the display device 100 may display the “user setting” 810 in the current mode 730, and move an item indicating the movie mode 702 from the current mode 730 to the recommended mode arrangement 740.

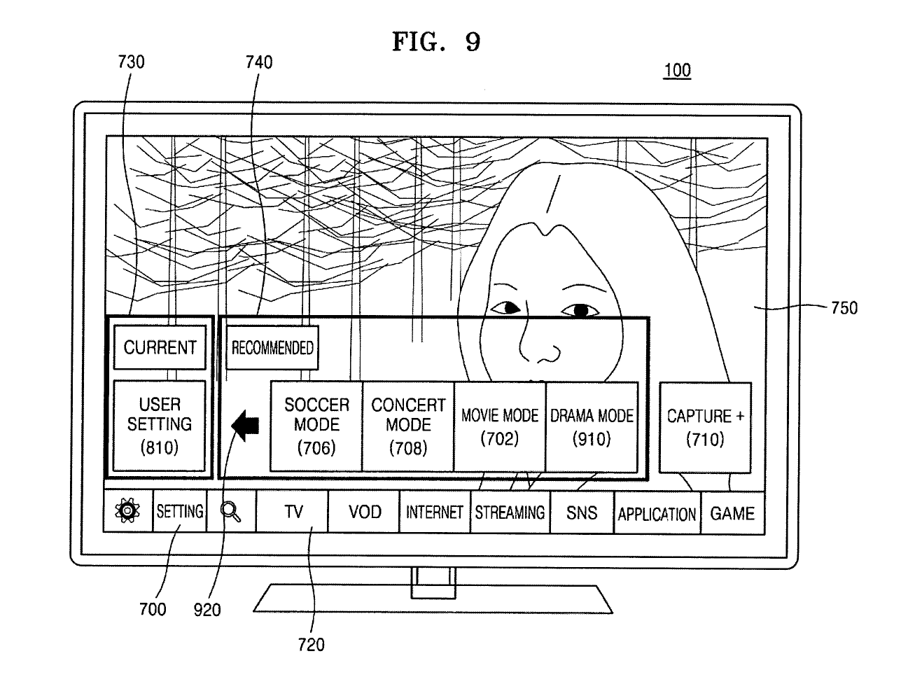

FIG. 9 illustrates a method of arranging the user's viewing environment generated according to the method of FIG. 8.

Referring to FIG. 8, the display device 100 may create a “drama mode” corresponding to a user's viewing environment generated based on environment setting information that is set by the user during watching of a drama 750. Referring to FIG. 9, the display device 100 may create an item “drama mode” 910.

The display device 100 may arrange the created item “drama mode” 910 between existing items, i.e., a “concert mode” 708 and a “capture” 710 in the recommended mode arrangement 740. In an embodiment, if the recommended mode arrangement 740 exceeds an available space on a screen of the display device 100, the display device 100 may display the recommended mode arrangement 740 by using a scroll bar (not shown) or an arrow item 920.

If a user input signal for selecting the arrow item 920 is received, the display device 100 may display an item “sports mode” 704. In this case, the item “drama mode” 910 may not be displayed while a right pointing arrow item may be displayed.

According to another embodiment, the display device 100 may display the item “drama mode” 910 in the current mode 730. In this case, the item “drama mode” 910 may not be added to the recommended mode arrangement 740.

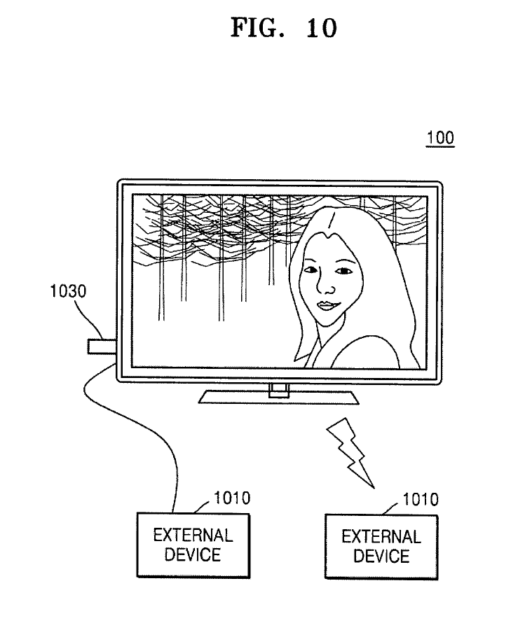

FIG. 10 illustrates a method whereby a display device 100 receives content from an external device, according to an embodiment. Referring to FIG. 10, the external device may be at least one of external devices 1010 and 1020 respectively connected to the display device 100 by wire and wirelessly.

The external device 1010 may be connected to the display device 100 via the I/O unit 170 of the display device 100 described with reference to FIG. 2. For example, a game machine, a DVD player, or an external hard disk may be connected to the display device 100 by wire. Furthermore, a USB memory 1030 may be directly connected to the display device 100.

For example, the external device 1010 may be connected to the display device by using one of the HDMI port 171, the component jack 172, the PC port 173, and the USB port 174 included in the display device 100.

Furthermore, the external device 1010 may be connected to the display device 100 by using a combination of the HDMI port 171, the component jack 172, the PC port 173, and the USB port 174. According to another embodiment, the external device 100 may be connected to the display device 100 via a wired Ethernet 153 shown in FIG. 2.

The external device 1020 may be connected to the display device 100 via the communication unit 150 of the display device described with reference to FIG. 2. For example, a smartphone or tablet may be connected wirelessly to the display device 100. In an embodiment, the external device 1020 may be connected to the display device 100 via a wireless local area network (WLAN) 151 or Bluetooth 152 shown in FIG. 2.

According to an embodiment, the display device 100 may receive content from external devices, i.e., the external devices 1010 and 1020 and the USB memory 1030. For example, the display device 100 may receive movie content from a DVD player. Furthermore, the display device 100 may receive a gameplay screen from a game machine.

According to another embodiment, the display device 100 may receive mirroring information including a screen displayed on a smartphone from the smartphone. Furthermore, the display device 100 may receive at least one piece of content from among photos, videos, and music stored on an external hard disk or USB memory.

According to an embodiment, the display device 100 may generate and store a user's viewing environment corresponding to each of the external devices 1010 and 1020 and the USB memory 1030. When each of the external devices 1010 and 1020 and the USB memory 1030 is connected to the display device 100, the display device 100 may set itself based on a user's viewing environment corresponding to the external device 1010, 1020, or 1030 connected thereto.

For example, if the user sets environment setting information while viewing content mirrored from a smartphone on the display device 100 during playback, the display device 100 may generate a user's viewing environment by mapping the set environment setting information to the smartphone that is an external device.

Thereafter, if the user uses the smartphone again to view content from the smartphone on the display device 100, the display device 100 may set itself by using the user's viewing environment generated for the smartphone.

This may allow the user to view content from the smartphone on the display device 100 in a uniform viewing environment.

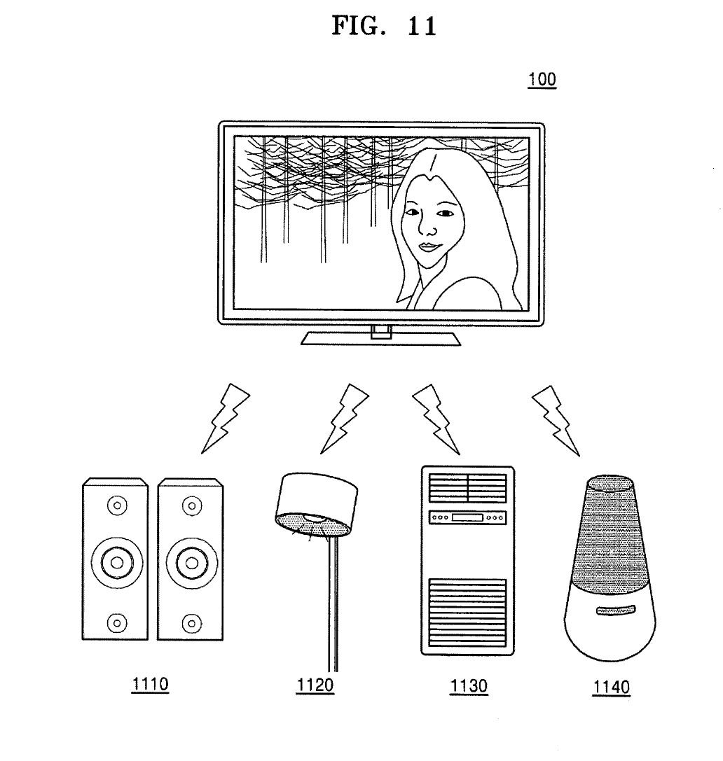

FIG. 11 illustrates a method whereby a display device 100 controls an external device, according to an embodiment.

Referring to FIG. 11, the display device 100 may be connected by wire or wirelessly to at least one from among external devices including a speaker 1110, a lighting unit 1120, an air conditioner 1130, and an aroma humidifier 1140.

According to an embodiment, environment setting information of the display device 100 may include setting information about at least one external device. For example, the environment setting information may include information for controlling a volume of an external speaker, information for adjusting the brightness of a lighting unit, information for adjusting a room temperature, information for adjusting aroma content of an aroma humidifier, etc.

The display device 100 may set itself based on the environment setting information including setting information about an external device. In this case, the display device 100 may transmit a control signal for controlling the external device via the I/O unit 170 or the communication unit 150 described with reference to FIG. 2.

For example, the user may set environment setting information while viewing movie content being played back on the display device 100. In this case, the environment setting information may include settings for controlling external devices, such as a setting for reducing the brightness of a lighting unit and a setting for increasing a volume of an external speaker.

The display device 100 may generate a user's viewing environment by mapping the set environment setting information to a movie that is metadata for the content being displayed on the display device 100. Thereafter, when the user watches the movie content again on the display device 100, the display device 100 may control not only a viewing environment of the display device 100 itself according to settings of the user's viewing environment corresponding to movie metadata, but also an external device by using settings for controlling the external device.

This configuration may allow the user to view movie content on the display device 100 in an environment that is preset for external devices while the user views the movie, i.e., in an environment where a volume of an external speaker is increased and a brightness of a lighting unit is reduced.

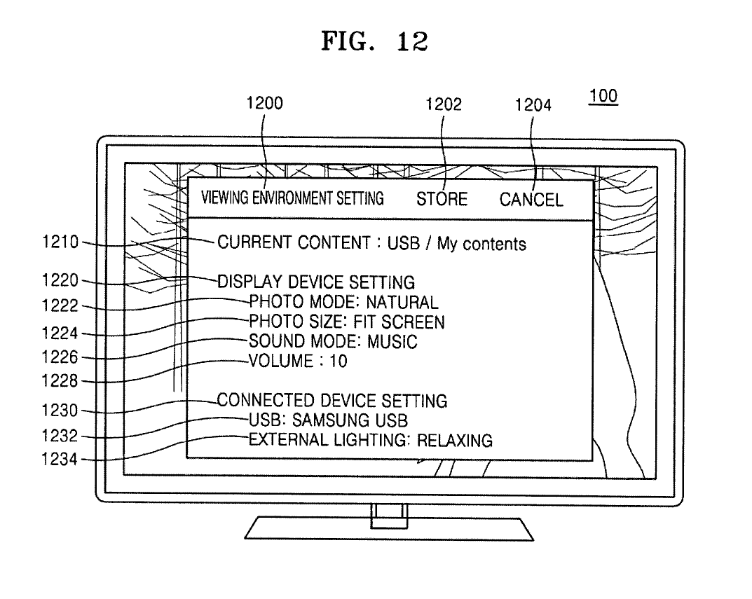

FIG. 12 illustrates a method of setting a viewing environment according to an embodiment. Referring to FIG. 12, the display device 100 may display a viewing environment setting screen 1200. According to an embodiment, the viewing environment setting screen 1200 may include information 1210 about current content.

The current content may be received from a “My contents” folder on the USB memory (1030 of FIG. 10 connected to the display device 100. According to an embodiment, the display device 100 may receive at least one of a photo and music from the USB memory 1030. Furthermore, the display device 100 may be connected to the lighting unit (1120 of FIG. 11).

According to an embodiment, the viewing environment setting screen 1200 may include setting information 1220 regarding the display device 100. For example, the viewing environment setting screen 1200 may include at least one of a photo mode 1222, a photo size 1224, a sound mode 1226, and a volume 1228.

Furthermore, the viewing environment setting screen 1200 may include setting information 1230 regarding an external device connected to the display device 100. For example, the viewing environment setting screen 1200 may include information 1232 about the USB memory 1030 connected to the display device 100 and setting information 1234 about the lighting unit 1120.

According to an embodiment, if the user selects a “store” item 1202, the edited environment setting information may be stored. Furthermore, if the user selects a “cancel” item 1204, editing of the environment setting information may be cancelled.

According to an embodiment, the display device 100 may generate a user's viewing environment by mapping the environment setting information displayed on the viewing environment setting screen 1200 to metadata for the content. Referring to FIG. 12, the metadata for the content may include at least one of connection of the USB memory 1030, a photo, and music.

According to an embodiment, the display device 100 may set a name of the generated user's viewing environment. For example, the display device 100 may set the name of the generated user's viewing environment as being a “USB connection mode” or “USB photo and music mode”.

According to an embodiment, when the USB memory 1030 is connected to the display device 100, the display device 100 may set itself based on the “USB connection mode”.

For example, if a Samsung USB is connected to the display device 100, the display device 100 may change a photo mode to a “natural” mode and adjust a photo size to fit a screen. Furthermore, the display device 100 may change a sound mode to a ‘music mode’ and a volume to 10. In addition, the display device 100 may transmit a control signal for changing the lighting unit 1120 to a relaxing lighting mode.

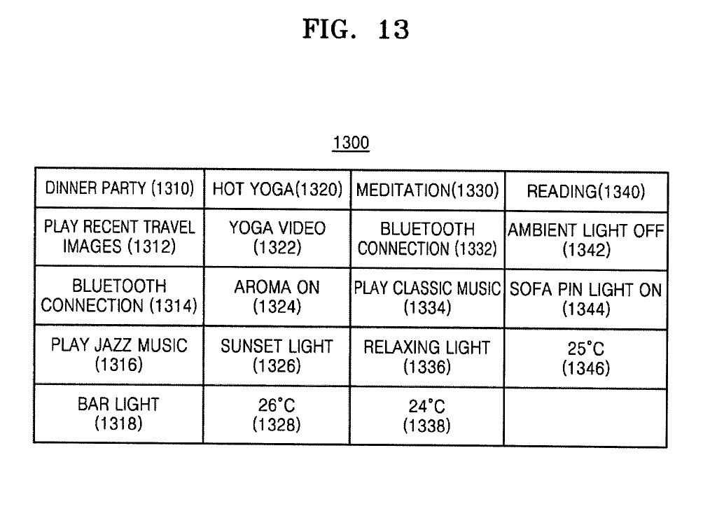

FIG. 13 shows a detailed example in which the display device 100 controls the display device 100 itself and external devices by using an extended user's viewing environment 1300, according to an embodiment. Referring to FIG. 13, the extended user's viewing environment 1300 may include a dinner party mode 1310, a hot yoga mode 1320, a meditation mode 1330, and a reading mode 1340.

When the display device 100 and external devices are set based on the dinner party mode 1310, the display device 100 may play back recent travel images (operation 1312). The display device 100 may also connect to a smartphone via Bluetooth (operation 1314).

The display device 100 may also play back a piece of jazz music stored on the smartphone (operation 1316). The display device 100 may also transmit a control signal for turning on bar light to an external lighting unit (operation 1318).

When the display device 100 and external devices are set based on the hot yoga mode 1320, the display device 100 may play back a yoga video (operation 1322). The display device 100 may also transmit a control signal for emitting an aroma to an aroma humidifier (operation 1324).

The display device 100 may transmit a control signal for turning on sunset light to an external lighting unit (operation 1326). The display device may also transmit a control signal for setting a room temperature to 26° C. to an air conditioner (operation 1328).

When the display device 100 and external devices are set based on the meditation mode 1330, the display device 100 may connect to the smartphone via Bluetooth (operation 1332). The display device 100 may also play back a piece of classic music stored on the smartphone (operation 1334).

The display device 100 may transmit a control signal for turning on relaxing light to an external lighting unit (operation 1336). The display device 100 may also transmit a control signal for setting a room temperature to 24° C. to an air conditioner (operation 1338).

When the display device 100 and external devices are set based on the reading mode 1340, the display device 100 may transmit a control signal for turning off the ambient light (operation 1342).

The display device 100 may also transmit a control signal for turning on sofa pin light (operation 1344). The display device 100 may also transmit a control signal for setting a room temperature to 25° C. to an air conditioner (operation 1346).

As described above, according to embodiments, it is possible to simply and easily generate and store user viewing information for setting the display device 100. Furthermore, the display device may be automatically set based on preset user viewing information corresponding to metadata for content. In addition, various external devices may be set together with the display device according to content displayed on the display device 100.

It will be understood by those of ordinary skill in the art that technology and principles described in the specification are not limited to the embodiments and changes may be appropriately made therein without departing from the spirit and scope of the disclosure.

Furthermore, while the embodiments are mainly implemented using hardware components, arbitrary processing may be accomplished by executing computer programs on a central processing unit (CPU).

In this case, the computer programs may be stored on various types of non-transitory computer readable media and be supplied to a computer via the non-transitory computer-readable media. The non-transitory computer-readable media include a variety of tangible storage media.

Examples of the non-transitory computer-readable media include magnetic storage media (e.g., flexible disks, magnetic tapes, and hard disk drives), magneto-optical storage media (e.g., magneto-optical disks), optical recording media (e.g., compact disc (CD)-read-only memory (ROM), CD-recordable (CD-R), and CD-rewritable (CD-R/W)), and semiconductor memories (e.g., mask ROM, Programmable ROM (PROM), erasable PROM (EPROM), flash ROM, and random access memory (RAM)).

Furthermore, programs may be supplied to a computer via various types of transitory computer-readable media. Examples of the transitory computer-readable media include electrical signals, optical signals, and electromagnetic waves. The transitory computer-readable media may supply programs to the computer via a wired communication path such as electric wires and optical fibers or a wireless communication path.

Although example embodiments have been shown and described, it would be appreciated by those skilled in the art that changes may be made to these embodiments without departing from the principles and spirit of the disclosure, the scope of which is defined in the claims and their equivalents.

1. A display device, comprising:
a display; and
a processor configured to receive environment setting information used to view content currently being displayed on the display, acquire metadata associated with the content displayed on the display, and generate a user's viewing environment by mapping the metadata to the environment setting information.

2. The display device of claim 1, wherein the processor is further configured to set the display device based on the user's viewing environment when at least one other piece of content corresponding to the metadata is displayed on the display.

3. The display device of claim 1, wherein the processor is further configured to generate, in response to a user input signal for selecting a specific item arranged in a user interface, the user's viewing environment by mapping the metadata to the environment setting information.

4. The display device of claim 1, further comprising a communication unit configured to receive the content from an external device,
wherein the metadata comprises information about the external device.

5. The display device of claim 4, wherein the processor is further configured to set the display device based on the user's viewing environment when the external device is connected to the display device.

6. The display device of claim 1, wherein the environment setting information is obtained by the user editing preset environment setting information.

7. The display device of claim 1, wherein the processor is further configured to set a name of the user's viewing environment based on the metadata.

8. The display device of claim 7, wherein the processor is further configured to acquire the name of the user's viewing environment and update the name based on a viewing pattern for at least one piece of content to which the user's viewing environment is applied.

9. The display device of claim 1, wherein
the environment setting information comprises setting information about at least one external device, and
the display device further comprises a communication unit configured to transmit, when at least one other piece of content corresponding to the metadata is displayed on the display, a control signal for controlling the at least one external device connected to the display device.

10. A method, performed by a display device, of generating a user's viewing environment, the method comprising:
receiving environment setting information used to view content currently being displayed on a display;
acquiring metadata associated with the content displayed on the display; and
generating a user's viewing environment by mapping the metadata to the environment setting information.

11. The method of claim 10, further comprising setting the display device based on the user's viewing environment when at least one other piece of content corresponding to the metadata is displayed on the display.

12. The method of claim 10, wherein the generating of the user's viewing environment comprises generating, in response to a user input signal for selecting a specific item arranged in a user interface, the user's viewing environment by mapping the metadata to the environment setting information.

13. The method of claim 10, further comprising receiving the content from an external device,
wherein the metadata comprises information about the external device.

14. The method of claim 13, further comprising setting the display device based on the user's viewing environment when the external device is connected to the display device.

15. The method of claim 10, wherein the environment setting information is obtained by the user editing preset environment setting information.

16. The method of claim 10, wherein the generating of the user's viewing environment comprises setting a name of the user's viewing environment based on the metadata.

17. The method of claim 16, further comprising:
acquiring the name of the user's viewing environment; and
updating the name based on a viewing pattern for at least one piece of content to which the user's viewing environment is applied.

18. The method of claim 10, wherein the environment setting information comprises setting information about at least one external device,
the method further comprising transmitting, when at least one other piece of content corresponding to the metadata is displayed on the display, a control signal for controlling the at least one external device connected to the display device.

19. A non-transitory computer-readable recording medium, having recorded thereon a program for performing the method of claim 10.

20. The display device of claim 2, wherein the processor is further configured to compare metadata of the at least one other piece of content and metadata of the user's viewing environment and set the display device based on the comparison.
